(19) United States
(12) Patent Application Publication
(10) Pub. No.: US 2026/0251798 A1
(43) Pub. Date: Aug. 27, 2026

(54) METAL ION LIDAR FOR DETECTING WIND -TEMPERATURE -DENSITY IN E-F REGIONS, AND DETECTION METHOD THEREOF

(71) Applicant: National Space Science Center, Chinese Academy of Sciences, Beijing (CN)

(72) Inventors: Lifang DU, Beijing (CN); Guotao YANG, Beijing (CN); Haoran ZHENG, Beijing (CN); Xuewu CHENG, Beijing (CN); Fang WU, Beijing (CN); Fuju WU, Beijing (CN); Yuan XIA, Beijing (CN); Jing JIAO, Beijing (CN); Faquan LI, Beijing (CN)

(73) Assignee: National Space Science Center, Chinese Academy of Sciences, Beijing (CN)

(21) Appl. No.: 18/875,883

(22) PCT Filed: Sep. 5, 2023
(86) PCT No.: PCT/CN2023/116974

§ 371 Date: Dec. 17, 2024

(30) Foreign Application Priority Data
Sep. 6, 2022 (CN) 2022110836029

(51) Int. Cl. G01S 17/95; G01S 7/481

(52) U.S. Cl. CPC G01S 17/95; G01S 7/4815; G01S 7/4818

(57) ABSTRACT

A metal ion Doppler lidar for detecting the wind-temperature-density in E-F regions, and a detection method. The lidar comprises a laser emission system (1), a telescope receiving system (2), and a signal acquisition and processing system (3); by using various laser devices and under the action of optical switches and a frequency converter, the laser emission system (1) outputs three-frequency-switched laser for detecting metal ions; the combination of laser beam splitter mirrors, laser highly reflective mirrors and the like realizes laser emission in vertical, east (west), north (south) directions which are consistent with receiving directions of the telescope receiving system (2); the telescope receiving system (2) receives echo signals in three directions, processes the echo signals separately to obtain electrical signals, and transmits the electrical signals to the signal acquisition and processing system (3) in a unified manner, so that the temperature and wind field in the E-F regions and the density of a metal layer can be simultaneously obtained. The detection of wind and temperature is implemented by a lidar using metal ions as tracers for the first time, thereby providing a detection means for implementing high-precision detection of the wind and temperature in E-F regions.

### TECHNICAL FIELD

The present invention relates to the field of lidar technology, in particular to a metal ion-based lidar for detecting the wind-temperature-density in E-F regions, and a detection method thereof, and more specifically to a metal ion Doppler mechanism-based lidar for detecting the wind-temperature-density in E-F regions, and a detection method thereof.

### BACKGROUND

Since 1969, when high-altitude sodium atom detection was achieved for the first time by Bowman et al. using a resonance fluorescence lidar, several research institutes have made measurements of sodium atom density using broadband resonance fluorescence lidars (Sandford and Gibson, 1970; Hake et al., 1972; Megie and Blamont, 1977). In China, Wuhan Institute of Physics and Mathematics, Chinese Academy of Sciences successfully developed in 1996 the first broadband sodium lidar in China, after which a number of institutes, such as Wuhan University, University of Science and Technology of China, and National Space Science Center, Chinese Academy of Sciences, successfully developed sodium fluorescence lidars and carried out a wide range of technological and applied research.

With the development of laser technology and optoelectronic devices, a resonance fluorescence lidar can produce narrow-line-width detection laser with a small beam divergence angle, so that a very high spatial and temporal resolution is achieved in atmospheric detection. Moreover, due to high energy and good monochromaticity of the detection laser, and its short pulse characteristics, in combination with narrow-band filtering or other filter means, the lidar achieves very high detection sensitivity. In addition, the wavelength of the laser also allows a wide-range tuning ability, which in turn enables the lidar to implement detection of various atmospheric components, such as K, Li, Fe, Ga, Ga⁺, Mg, Ni and other metal atoms and ions.

The atmospheric wind and temperature at the top of the troposphere (80-110 km) can be measured with high precision using a resonance fluorescence lidar. In the prior art, with sodium atoms as tracers, and based on the Doppler measurement mechanism (utilizing Doppler broadening and frequency shifting of scattering spectra of atoms and molecules in the atmosphere with changes in temperature and radial velocity, inversion is performed based on echo signals to obtain temperature and wind field information), lasers with a high power, a narrow line width, and high frequency stability are used as an emission system to obtain, in real time, a high-precision vertical profile of an atmospheric wind field and a three-dimensional stereoscopic scanning wind field.

As to detection altitudes of metal atom and ion layers achievable with resonance fluorescence lidars, literature (Gong S, et. al. A double sodium layer event observed over Wuhan, China by lidar, Geophysical Research Letters, 2003, 30 (5):13-1) reported that Gong et. al. observed, in Wuhan, China, a sodium atom layer extending up to 120 km; literature (Chu X, et. al. Lidar observations of neutral Fe layers and fast gravity waves in the thermosphere (110-155 km) at McMurdo (77.8° S,166.7° E,), Antarctica, Geophysical Research Letters, 2011, 38(23):23807) reported that chu et. al. observed an iron atom layer at 155 km; and literature (Xun Yuchang, Lidar observation and study of mid-latitude thermospheric sodium layer, University of Chinese Academy of Sciences (National Space Science Center)) detected a thermospheric sodium atom layer extending up to 200 km using a Rayleigh sodium fluorescence lidar of the Meridian Project. These special features of vertical atom distribution have broadened people's knowledge about metal layers, and the detection ranges of temperature and wind field have been effectively expanded as well. Literature (Liu A Z, et. al. First measurement of horizontal wind and temperature in the lower thermosphere (105-140 km) with a Na Lidar at Andes Lidar Observatory, Geophysical Research Letters, 2016, 43(6):2374-2380) reported a sodium atom layer at 140 km and achieved detection of the temperature and wind field at the altitude.

However, up to now, there has not been any metal ion Doppler mechanism-based lidar for detecting the wind field and temperature in the upper atmosphere, and in particular, lidar detection that extends the range of wind field and temperature detection from the E layer to the F layer at higher altitudes has not been reported.

### SUMMARY OF THE INVENTION

An object of the present invention is to propose a system and a method of a metal ion Doppler mechanism-based lidar for detecting the wind field and temperature in the upper atmosphere and density, which can achieve detection of the wind-temperature-density in E-F regions.

The present invention proposes a metal ion-based lidar for detecting the wind-temperature-density in E-F regions, wherein the lidar uses metal ions as tracers to detect the E-F regions in the atmosphere, and the lidar includes a laser emission system, a telescope receiving system, and a signal acquisition and processing system;
the thermosphere laser emission system is configured to output three-frequency-switched laser light for detecting metal ions, by using various laser devices and under the action of optical switches and a frequency converter; the combination of beam splitter mirrors and highly reflective mirrors realizes laser emission in different directions which are consistent with receiving directions of the telescope receiving system;
the telescope receiving system is configured to receive echo signals in various directions, process the echo signals in the various directions separately to obtain electrical signals, and then transmit the electrical signals to the signal acquisition and processing system in a unified manner; and
the signal acquisition and processing system is configured to acquire and process the electrical signals transmitted by the telescope receiving system to obtain the temperature and wind field in the E-F regions and the density of a metal layer.

As one of improvements of the above technical solution, the laser emission system includes: a first seed laser, a high-power pulse pumped laser, an optical parametric oscillator-amplifier laser, a second seed laser, a three-frequency switching module, a nonlinear frequency converter, a laser beam expander mirror, a first beam splitter mirror, a second laser beam splitter mirror, a first laser highly reflective mirror, a second laser highly reflective mirror, and a third laser highly reflective mirror;
the first seed laser is configured to generate narrow-line-width seed laser light and inject the narrow-line-width seed laser light into the high-power pulse pumped laser;
the high-power pulse pumped laser is configure to generate single-longitudinal-mode pumped laser light based on the injected narrow-line-width seed laser, and inject the pumped laser into the optical parametric oscillator-amplifier laser, or inject the pumped laser into the optical parametric oscillator-amplifier laser and the nonlinear frequency converter;
the second seed laser is configured to generate narrow-line-width seed laser, and input the narrow-line-width seed laser into the three-frequency switching module;
the three-frequency switching module is configured to perform frequency shifting on the input narrow-line-width seed laser, specifically: converting the narrow-line-width seed laser with a frequency f₀ injected by the second seed laser into laser with frequencies f₀+Δf, f₀ and f₀−Δf, and injecting the frequency-converted laser into the optical parametric oscillator-amplifier laser, where Δf is a frequency shift amount, which is set according to wind and temperature measurement principles;
the optical parametric oscillator-amplifier laser is configured to generate single-longitudinal-mode narrow-line-width signal laser based on the laser injected by the high-power pulse pumped laser and the three-frequency switching module, and irradiate the single-longitudinal-mode narrow-line-width signal laser to the nonlinear frequency converter;
the nonlinear frequency converter is configured to generate metal-ion resonant laser by an optical nonlinear effect based on the signal laser irradiated by the optical parametric oscillator-amplifier laser, or based on two types of laser light irradiated by both the high-power pulse pumped laser and the optical parametric oscillator-amplifier laser, and irradiate the metal-ion resonant laser to the laser beam expander mirror;
the laser beam expander mirror is configured to adjust a beam divergence angle of the metal-ion resonant laser irradiated by the nonlinear frequency converter, and irradiate the adjusted beam to the first laser beam splitter mirror;
the first laser beam splitter mirror is configured to split the metal-ion resonant laser irradiated by the laser beam expander mirror into two beams, a transmitted beam and a reflected beam;
the second highly reflective mirror is configured to reflect the reflected beam output from the first laser beam splitter mirror into the air in a direction pointing east or west;
the second beam splitter mirror is configured to split the transmitted beam output from the first beam splitter mirror into two beams, a transmitted beam and a reflected beam again, and reflect the reflected beam into the sky in a direction pointing vertically; and
the first highly reflective mirror is configured to reflect the transmitted beam output from the second beam splitter mirror to the third highly reflective mirror, such that the beam is reflected by the third highly reflective mirror into the sky in a direction pointing south or north.

As one of improvements of the above technical solution, the three-frequency switching module includes a first optical switch, a frequency up-converter, an optical fiber, a frequency down-converter, and a second optical switch;
the frequency up-converter is configured to perform frequency up-shifting on the laser input into the three-frequency switching module, so that an output laser frequency is converted from f₀ to f₀+Δf;
the optical fiber is configured to directly transmit the laser input into the three-frequency switching module;
the frequency down-converter is configured to perform frequency down-shifting on the laser injected into the three-frequency switching module, so that an output laser frequency is converted from f₀ to f₀−Δf;
the frequency up-converter, the optical fiber and the frequency down-converter are connected to the second seed laser via the first optical switch and connected to the optical parametric oscillator-amplifier laser via the second optical switch, respectively, for controlling a frequency of the laser input to the three-frequency switching module to be processed in an up-shift, down-shift or unchanged manner;
the first optical switch is configured to control timing switching of the second seed laser irradiating to the frequency up-converter, the optical fiber and the frequency down-converter; and
the second optical switch is configured to control the laser, which is subjected to the timing switching of the frequency up-converter, the optical fiber and the frequency down-converter, to be irradiated to the optical parametric oscillator-amplifier laser.

As one of improvements of the above technical solution, the telescope receiving system includes: a zenith pointing east or west receiving telescope, a zenith pointing vertical receiving telescope, a zenith pointing south or north receiving telescope, a first optical signal transmitting fiber, a second optical signal transmitting fiber, a third optical signal transmitting fiber, a first optical signal collimating focuser, a second optical signal collimating focuser, a third optical signal collimating focuser, a first photodetector, a second photodetector and If a third photodetector;
the zenith pointing east or west receiving telescope is configured to receive back-scattered echo signals of the laser reflected into the sky by the second highly reflective mirror and converge the signals into the third optical signal transmitting fiber so as to be transmitted to the first optical signal collimating focuser; the first optical signal collimating focuser is configured to focus optical signals and inject the focused optical signals into a detection end face of the first photodetector; and the first photodetector is configured to convert the optical signals into electrical signals and output the electrical signals;
the zenith pointing vertical receiving telescope is configured to receive back-scattered echo signals of the laser reflected into the sky by the second laser beam splitter mirror and converge the signals into the second optical signal transmitting fiber so as to be transmitted to the second optical signal collimating focuser; the second optical signal collimating focuser is configured to focus optical signals and inject the focused optical signals into a detection end face of the second photodetector; and the second photodetector is configured to convert the optical signals into electrical signals and output the electrical signals;
the zenith pointing south or north receiving telescope is configured to receive back-scattered echo signals of the laser reflected into the sky by the third highly reflective mirror and converge the signals into the first optical signal transmitting fiber so as to be transmitted to the third optical signal collimating focuser; the third optical signal collimating focuser is configured to focus optical signals and inject the focused optical signals into a detection end face of the third photodetector; and the third photodetector is configured to convert the optical signals into electrical signals and output the electrical signals.

As one of improvements of the above technical solution, the signal acquisition and processing system includes: a multi-channel data acquisition module configured to receive the electrical signals output by the first photodetector, the second photodetector and the third photodetector.

As one of improvements of the above technical solution, the signal acquisition and processing system further includes: a timing control module, a first timing control signal line, a second timing control signal line, a third timing control signal line, a fourth timing control signal line, and a fifth timing control signal line; and
the timing control module is configured to control signal synchronization of the high-power pulse pumped laser, the three-frequency switching module and the multi-channel data acquisition module via the first timing control signal line, the second timing control signal line, the third timing control signal line, the fourth timing control signal line and the fifth timing control signal line.

The present invention also proposes a detection method of a metal ion-based lidar for detecting the wind-temperature-density in E-F regions, which is used to detect the wind-temperature-density in E-F regions based on the metal ion-based lidar for detecting the wind-temperature-density in E-F regions described above, wherein the method includes:
injecting, by the first seed laser, narrow-line-width seed laser into the high-power pulse pumped lase to generate single-longitudinal-mode pumped laser, and injecting the pumped laser into the optical parametric oscillator-amplifier laser, or injecting the pumped laser into the optical parametric oscillator-amplifier laser and the nonlinear frequency converter;
inputting, by the second seed laser, narrow-line-width seed laser into the three-frequency switching module;
outputting, by the timing control module, a timing control signal, and transmitting the timing control signal to the three-frequency switching module via the third timing control signal line, the fourth timing control signal line and the fifth timing control signal line; controlling, by the three-frequency switching module, a first optical switch and a second optical switch to be communicated with a frequency up-converter, a frequency down-converter or an optical fiber according to the timing control signal, such that the input laser passes through the frequency up-converter, the frequency down-converter or the optical fiber respectively according to a time series, so that a frequency of output laser is processed in an up-shift, down-shift or unchanged manner, and injecting the processed laser into the optical parametric oscillator-amplifier laser in a time-division manner based on timing control; generating, by the optical parametric oscillator-amplifier laser, single-longitudinal-mode narrow-line-width signal laser under the joint action of a pumping effect of the high-power pulse pumped laser and the laser input from the If three-frequency switching module, and irradiating the single-longitudinal-mode narrow-line-width signal laser to the nonlinear frequency converter to obtain metal-ion resonant laser, or irradiating both the generated single-longitudinal-mode narrow-line-width signal laser and the single-longitudinal-mode pumped laser generated by the high-power pulse pumped laser to the nonlinear frequency converter to obtain metal-ion resonant laser, and irradiating the metal-ion resonant laser to the laser beam expander mirror;
splitting, by the first beam splitter mirror, the light output by the laser beam expander mirror into two beams, a transmitted beam and a reflected beam, wherein the reflected beam is irradiated to the second laser highly reflective mirror and reflected by the second laser highly reflective mirror into the sky in a direction pointing east or west, and the transmitted beam is irradiated to the second beam splitter mirror;
splitting, by the second beam splitter mirror, the irradiated beam into two beams, a transmitted beam and a reflected beam again, wherein the reflected beam is reflected directly into the sky in a direction pointing vertically, and the transmitted beam is irradiated to the first laser highly reflective mirror;
reflecting, by the first highly reflective mirror, the light to a third highly reflective mirror, and reflecting, by the third highly reflective mirror, the light into the sky in a direction pointing south or north;
receiving, by the zenith pointing east or west receiving telescope, back-scattered echo signals of the laser reflected into the sky by the second high reflector, wherein the back-scattered echo signals are generated by resonant scattering of the laser emitted into the sky with metal layer ions, and converging the signals into the third optical signal transmitting fiber so as to be transmitted to the first optical signal collimating focuser; focusing optical signals and injecting the focused optical signals into the detection end face of the first photodetector by the first optical signal collimating focuser; and converting the optical signals into electrical signals and outputting the electrical signals by the first photodetector;
receiving, by the zenith pointing vertical receiving telescope, back-scattered echo signals of the laser reflected into the sky from the second beam splitter mirror, and converging the signals into the second optical signal transmitting fiber so as to be transmitted to the second optical signal collimating focuser; focusing optical signals and injecting the focused optical signals into the detection end face of the second photodetector by the second optical signal collimating focuser; and converting the optical signals into electrical signals and outputting the electrical signals by the second photodetector;
receiving, by the zenith pointing south or north receiving telescope, back-scattered echo signals of the laser reflected into the sky from the third highly reflective mirror, and converging the signals into the first optical signal transmitting fiber so as to be transmitted to the third optical signal collimating focuser; focusing optical signals and injecting the focused optical signals into the detection end face of the third photodetector by the third optical signal collimating focuser; and converting the optical signals into electrical signals and outputting the electrical signals by the third photodetector; and
receiving, by the multi-channel data acquisition module, the electrical signals output by the first photodetector, the second photodetector and the third photodetector.

As one of improvements of the above technical solution, controlling, by the three-frequency switching module, a first optical switch and a second optical switch to be communicated with a frequency up-converter, a frequency down-converter or an optical fiber (107) according to the timing control signal, so that a frequency of injected laser is processed in an up-shift, down-shift or unchanged manner, and injecting the processed laser into the optical parametric oscillator-amplifier laser specifically includes:
when the timing control module outputs the timing control signal via the third timing control signal line, and when the control signal is at a high level, a first channel of the first optical switch is turned on, and an optical signal is fed into the frequency up-converter, so that the frequency of the laser is converted from f₀ to f₀+Δf, and then the optical signal is fed into a first channel of the second optical switch; at that time, under timing signal control, the control signal is also at a high level, so that the first channel is turned on, and finally the optical signal with the frequency f₀+Δf is injected into the optical parametric oscillator-amplifier laser; the duration of the high level is Δt, and when the control signal is converted from the high level to a low level after the elapse of the time Δt, the first channel of the first optical switch and the first channel of the second optical switch are turned off; the third timing control signal line, the fourth timing control signal line, and the fifth timing control signal line output alternate high and low levels, wherein the duration of the low level is 2Δt;
when the timing control module outputs the timing control signal via the fourth timing control signal line, and when the control signal is at a high level, a second channel of the first optical switch is turned on, and an optical signal is fed into a second channel of the second optical switch, so that the second channel is turned on under timing signal control; the frequency of the optical signal is unchanged at that time and is f₀, and finally the optical signal with the frequency f₀ is injected into the optical parametric oscillator-amplifier laser; and
when the timing control module outputs the timing control signal via the fifth timing control signal line, and when the control signal is at a high level, a third channel of the first optical switch is turned on, and an optical signal is fed into the frequency down-converter, so that the frequency of the laser is converted from f₀ to f₀−Δf, then the optical signal is fed into a third channel of the second optical switch, the third channel is turned on under timing signal control, and finally the optical signal with the frequency f₀−Δf is injected into the optical parametric oscillator-amplifier laser.

As one of improvements of the above technical solution, the frequency shift amount Δf has a plurality of set values according to wind and temperature measurement principles.

The present application has the following technical effect: the wind-temperature-density in E-F regions can be detected by using the new lidar detection technology.

Compared with the prior art, the present invention has the following advantages:
1. a metal ion-based lidar is used for the first time to detect the wind and temperature; and
2. the detection range of wind, temperature and density is extended from the bottom of the layer E to the layer F, thereby greatly expanding the lidar's detection range of wind, temperature and density, and achieving an unprecedented breakthrough of new technology for detecting wind, temperature and density.

### BRIEF DESCRIPTION OF THE DRAWINGS

FIG. 1 is a compositional structure block diagram of a metal ion Doppler mechanism-based lidar for detecting the wind-temperature-density in E-F regions;

FIG. 2 is a compositional block diagram of a three-frequency switching module;

FIG. 3 is a three-frequency (f₋, f₀, f₊) echo photon signal graph at 80-300 km, wherein FIG. 3(a) is an f₊ echo photon signal graph at 80-300 km, FIG. 3(b) is an f₋ echo photon signal graph at 80-300 km, and FIG. 3(c) is an f₀ echo photon signal graph at 80-300 km;

FIG. 4 is a graph of judgment results for implementing wind detection results;

FIG. 5 is a graph of judgment results for implementing temperature detection results; and

FIG. 6 is another compositional structure block diagram of a metal ion Doppler mechanism-based lidar for detecting the wind-temperature-density in E-F regions.

### REFERENCE NUMERALS

1, laser emission system 2, telescope receiving system
3, data acquisition and processing system
101, first seed laser 102, high-power pulse pumped laser
103, optical parametric oscillator-amplifier laser 104, second seed laser
105, first optical switch 106, frequency up-converter
107, optical fiber 108, frequency down-converter 109, second optical switch
110, three-frequency switching module 111, non-linear frequency converter
112, laser beam expander mirror 113, first beam splitter mirror
114, second beam splitter mirror 115, first highly reflective mirror
116, second highly reflective mirror 117, third highly reflective mirror
201, zenith pointing east or west receiving telescope
202, zenith pointing vertical receiving telescope
203, zenith pointing north or south receiving telescope
204, first optical signal transmitting optical fiber
205, second optical signal transmitting fiber
206, third optical signal transmitting fiber
207, first optical signal collimating focuser
208, second optical signal collimating focuser
209, third optical signal collimating focuser 210, first photodetector
211, second photodetector 212, third photodetector
301, multi-channel data acquisition module 302, timing control module
303, first timing control signal line 304, second timing control signal line
305, third timing control signal line 306, fourth timing control signal line
307 fifth timing control signal line

### DETAILED DESCRIPTION

A metal ion Doppler mechanism-based lidar for detecting the wind field and temperature in the upper atmosphere and density proposed in the present invention includes a laser emission system 1, a telescope receiving system 2, and a data acquisition and processing system 3.

The laser emission system includes: a first seed laser 101, a high-power pulse pumped laser 102, an optical parametric oscillator-amplifier laser 103, a second seed laser 104, a three-frequency switching module 110, a nonlinear frequency converter 111, a laser beam expander mirror 112, a first laser beam splitter mirror 113, a second laser beam splitter mirror 114, a first laser highly reflective mirror 115, a second laser highly reflective mirror 116, and a third laser highly reflective mirror 117, wherein the three-frequency switching module 110 includes a first optical switch 105, a frequency up-converter 106, an optical fiber 107, a frequency down-converter 108, and a second optical switch 109;
the telescope receiving system 2 includes: a zenith pointing east (west) receiving telescope 201, a zenith pointing vertical receiving telescope 202, a zenith pointing south (north) receiving telescope 203, a first optical signal transmitting fiber 204, a second optical signal transmitting fiber 205, a third optical signal transmitting fiber 206, a first optical signal collimating focuser 207, a second optical signal collimating focuser 208, a third optical signal collimating focuser 209, a first photodetector 210, a second photodetector 211, and a third photodetector 212;
the signal acquisition and processing system 3 includes: a multi-channel data acquisition module 301, a timing control module 302, a first timing control signal line 303, a second timing control signal line 304, a third timing control signal line 305, a fourth timing control signal line 306, and a fifth timing control signal line 307.

A detection method of a metal ion Doppler mechanism-based lidar for detecting the wind field and temperature in the upper atmosphere and density of the present invention includes steps as follows:
the first seed laser 101 injects narrow-line-width seed laser light into the high-power pulse pumped laser 102 to generate single-longitudinal-mode pumped laser, which is a flat-top beam with uniform energy; the pumped laser generated by the high-power pulse pumped laser 102 is irradiated to the optical parametric oscillator-amplifier laser, which generates single-longitudinal-mode narrow-line-width signal laser under the action of seed injection by the second optical switch 109; the signal laser enters the nonlinear frequency converter 111, which generates metal-ion resonant laser by an optical nonlinear effect; the second seed laser 104 is first connected through the first optical switch 105 to the frequency up-converter 106, the optical fiber 107, and the frequency down-converter 108, respectively, and then is connected to the second optical switch 109;
when the timing control module 302 outputs a timing control signal via the third timing control signal line 305, a first channel of the first optical switch 105 is turned on, and an optical signal is fed into the frequency up-converter 106, so that a frequency of laser is converted from f₀ to f₀+Δf, and then the optical signal is fed into a first channel of the second optical switch 109; under the control of the fourth timing control signal line 306, the first channel is turned on, and finally the optical signal f₀+Δf is injected into the optical parametric oscillator-amplifier laser 103; likewise, a second channel of the first optical switch 105 is turned on, and an optical signal is fed into a second channel of the second optical switch 109, so that the second channel is turned on under timing signal control; the frequency of the optical signal is unchanged at that time and is f₀, and finally the optical signal f₀ is injected into the optical parametric oscillator-amplifier laser 103; and under the control of the fifth timing control signal line 307, a third channel of the first optical switch 105 is turned on, and an optical signal is fed into the frequency down-converter 108, so that a frequency of laser light is converted from f₀ to f0−Δf, then an optical signal is fed into a third channel of the second optical switch 109, the third channel is turned on under timing signal control, and finally the optical signal f₀−Δf is injected into the optical parametric oscillator-amplifier laser 103;
the metal-ion resonant laser output by the nonlinear frequency converter 111 enters into the laser beam expander mirror 112, and light output from the beam expander mirror is split into 2 beams through the first laser beam splitter mirror 113, wherein one beam is transmitted and irradiated to the second laser beam splitter mirror 114, and the other beam is reflected and irradiated to the second laser highly reflective mirror 116, and then is reflected into the sky; as to the light beam irradiated to the second laser beam splitter mirror 114, one beam is directly reflected into the sky, and the other beam is transmitted, and the transmitted light is then irradiated to the first laser highly reflective mirror 115, which reflects the laser to the third highly reflective mirror 117, and the highly reflective mirror reflects the laser into the sky;
the zenith pointing east (west) receiving telescope 201 receives back-scattered echo signals of the laser reflected into the sky by the second highly reflective mirror 116, the signals are converged by the telescope into the third optical signal transmitting fiber 206, then echo signals are focused by the first optical signal collimating focuser 207, and the focused optical signals are injected into a detection end face of the first photodetector 210, and at that time, the echo signals are converted into electrical signals and output; subsequent receiving optical paths of the other two receiving telescopes, i.e., the zenith pointing vertical receiving telescopes 202 and zenith pointing south (north) receiving telescopes 203 are similar to that of the zenith pointing east (west) receiving telescope 201;
the timing control module 302 controls the high-power pulse pumped laser 102, the three-frequency switching module 110 and the multi-channel data acquisition module 301 via the first timing control signal line 303, the second timing control signal line 304, the third timing control signal line 305, the fourth timing control signal line 306 and the fifth timing control signal line 307 to achieve signal synchronization thereof.

The technical solution provided in the present invention is further described below in conjunction with embodiments.

A calcium ion-based lidar for detecting the wind field and temperature and density, and a detection method thereof are used as examples in embodiments to illustrate and explain the present invention.

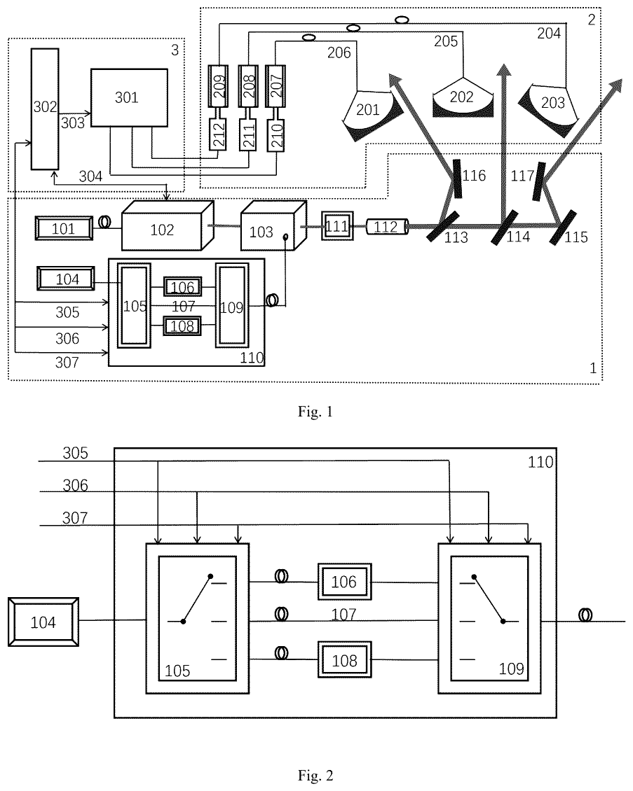

As shown in FIG. 1, which is a compositional block diagram of a calcium ion Doppler mechanism-based lidar for detecting the wind-temperature-density in E-F regions in embodiments of the present invention. The detection lidar includes a laser emission system 1, a telescope receiving system 2, and a data acquisition and processing system 3.

The laser emission system includes: a 1064 nm seed laser 101, a high-power pulse YAG laser 102, an optical parametric oscillator-amplifier laser 103, a 786 nm seed laser 104, a three-frequency switching module 110, a nonlinear frequency converter 111, a laser beam expander mirror 112, a first beam splitter mirror 113, a second beam splitter mirror 114, a first highly reflective mirror 115, a second highly reflective mirror 116, and a third highly reflective mirror 117, wherein the three-frequency switching module 110 includes a first optical switch 105, a frequency up-converter 106, an optical fiber 107, a frequency down-converter 108, and a second optical switch 109;
the telescope receiving system includes: a zenith pointing east receiving telescope, a zenith pointing vertical receiving telescope 202, a zenith pointing north receiving telescope 203, a first optical signal transmitting fiber 204, a second optical signal transmitting fiber 205, a third optical signal transmitting fiber 206, a first optical signal collimating focuser 207, a second optical signal collimating focuser 208, a third optical signal collimating focuser 209, a first photodetector 210, a second photodetector 211, and a third photodetector 212;
the signal acquisition and processing system includes: a multi-channel data acquisition module 301, a timing control module 302, a first timing control signal line 303, a second timing control signal line 304, a third timing control signal line 305, a fourth timing control signal line 306, and a fifth timing control signal line 307;
wherein the 1064 nm seed laser 101 injects narrow-line-width seed laser light into the high-power pulse YAG laser 102 to generate single-longitudinal-mode narrow-line-width 1064 nm pumped laser, which is a flat-top beam with uniform energy; the 1064 nm pumped laser is irradiated to the optical parametric oscillator-amplifier laser 103, and under the gating action of the second optical switch 109, an up-conversion frequency or a down-conversion frequency or an unchanged frequency is cyclically gated and fed into the optical parametric oscillator-amplifier laser 103; under the action of the pumped laser and the seed injection laser, the optical parametric oscillator-amplifier laser 103 generates high-power laser with the same frequency as seed injection; the laser enters into the nonlinear frequency converter 111, which generates 393 nm detection laser by frequency doubling, or generates 393 nm detection laser by a sum frequency of the laser and the pumped laser.

As shown in FIG. 2, which is a compositional block diagram of a three-frequency switching module 110 in embodiments of the present invention. For the three-frequency switching module 110, when the first channels of the first optical switch 105 and the second optical switch 109 are gated, and the frequency up-converter 106 is turned on, the output frequency is f₀+Δf, where Δf is 325 MHz, and for the light output from the nonlinear frequency converter 111, Δf′=650 MHz; if the second channels of the first optical switch 105 and the second optical switch 109 are gated, the output frequency is f₀, where Δf is 0, and for the laser output from the nonlinear frequency converter 111, Δf′=0 MHz, and no frequency shift occurs at that time; if the third channels of the first optical switch 105 and the second optical switch 109 are gated, and the frequency up-converter 106 is turned on, the output frequency is f₀−Δf, where Δf is 325 MHz, and for the laser output from the nonlinear frequency converter 111, Δf′=650 MHz;
the metal-ion resonant laser output by the nonlinear frequency converter 111 enters into the laser beam expander mirror 112, and laser output from the beam expander mirror is split into 2 beams through the first beam splitter mirror 113, wherein one beam is transmitted and irradiated to the second beam splitter mirror 114, and the other beam is reflected and irradiated to the second highly reflective mirror 116, and then is reflected into the sky; as to the laser irradiated to the second beam splitter mirror 114, one beam is directly reflected into the sky, and the other beam is transmitted, and the transmitted laser is then irradiated to the first highly reflective mirror 115, which reflects the laser to the third laser highly reflective mirror 117, and the highly reflective mirror reflects the laser into the sky;
the zenith pointing east receiving telescope 201 receives back-scattered echo signals of the laser reflected into the air by the second highly reflective mirror 116, the signals are converged by the telescope into the third optical signal transmitting fiber 206, then optical signals are focused by the first optical signal collimating focuser 207, and the focused optical signals are injected into a detection end face of the first photodetector 210, and at that time, the optical signals are converted into electrical signals and output; the zenith pointing vertical receiving telescope 202 receives back-scattered echo signals of the laser reflected into the sky by the second laser beam splitter mirror 114, the signals are converged by the telescope into the second optical signal transmitting fiber 205, then optical signals are focused by the second optical signal collimating focuser 208, and the focused optical signals are injected into a detection end face of the second photodetector 211, and at that time, the optical signals are converted into electrical signals and output; the zenith pointing north receiving telescope 201 receives back-scattered echo signals of the laser reflected into the sky by the third laser highly reflective mirror 117, the signals are converged by the telescope into the first optical signal transmitting fiber 204, then optical signals are focused by the third optical signal collimating focuser 209, and the focused optical signals are injected into a detection end face of the third photodetector 212, and at that time, the optical signals are converted into electrical signals and output; Finally, the 3 paths of electrical signals are collected and inverted by the multi-channel data acquisition module 301 under the signal synchronization action of the timing control module 302. Further inversion is performed based on the relationship between detected signal strength and changes in the temperature and wind speed to obtain temperature and wind information of the E-F regions. Atmospheric temperature and wind inversion methods based on the Doppler mechanism are common knowledge known in the art.

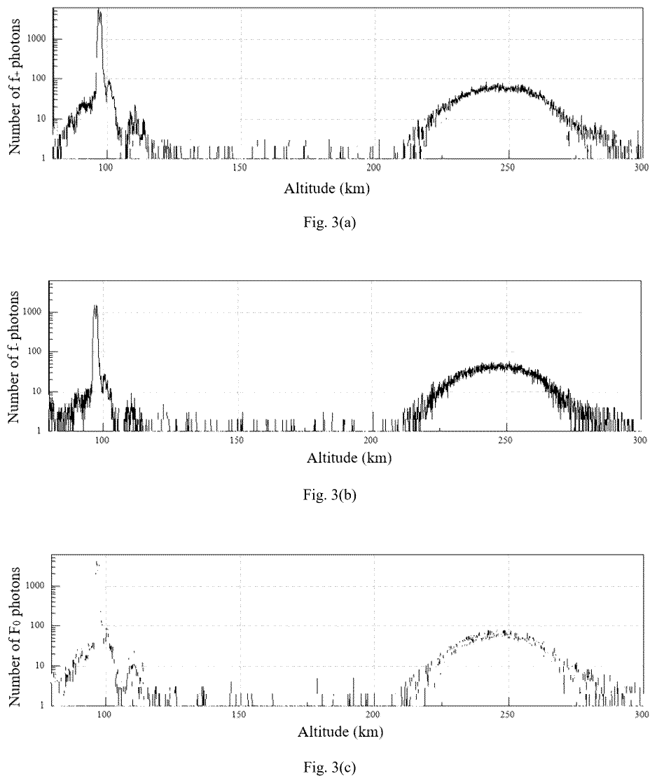

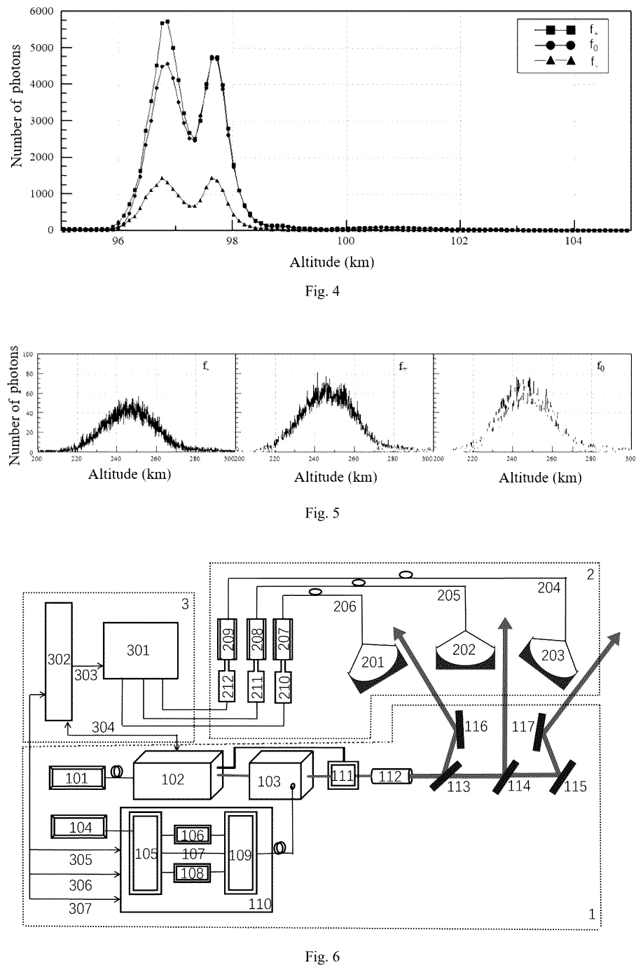

As shown in FIG. 3, which is three-frequency (f₋, f₀, f₊) echo signal graphs at 80-300 km in embodiments of the present invention, wherein FIG. 3(a) is an f₊ echo signal graph at 80-300 km, FIG. 3(b) is an f₋ echo signal graph at 80-300 km, and FIG. 3(c) is an f₀ echo signal graph at 80-300 km. As shown in FIG. 4, which is a graph of wind judgment results of three-frequency (f₋, f₀, f₊) detection results in embodiments of the present invention. It can be seen from the detection result graph that a three-frequency ratio at 96.7 km is inconsistent with a three-frequency ratio at 97.6 km, which indicates that vertical velocities at the two peaks are obviously different. As shown in FIG. 5, which is a graph of temperature judgment results of the three-frequency (f₋, f₀, f₊) detection results in embodiments of the present invention. It can be seen from the detection result graph that differences between the echo signals of the three frequencies (f₋, f₀, f₊) become smaller, so it can be determined that the atmospheric temperature in this altitude region is very high. (In the figure, f₋ denotes downward shifting of the frequency, i.e., corresponding to f₀−Δf, and f₊ denotes upward shifting of the frequency, i.e., corresponding to f₀+Δf.)

In fact, another detection is also carried out in this embodiment, as shown in FIG. 6: narrow-line-width seed laser light is injected into the high-power pulse pumped laser 102 using the first seed laser 101 to generate single-longitudinal-mode pumped laser, and the pumped laser is injected into the optical parametric oscillator-amplifier laser 103 and the nonlinear frequency converter 111; single-longitudinal-mode narrow-line-width signal laser is generated by using the optical parametric oscillator-amplifier laser 103 under the joint action of a pumping effect of the high-power pulse pumped laser 102 and the laser input from the If three-frequency switching module 110, and both the generated single-longitudinal-mode narrow-line-width signal laser and the single-longitudinal-mode pumped laser generated by the high-power pulse pumped laser 102 are irradiated to the nonlinear frequency converter 111 to obtain metal-ion resonant laser, and the metal-ion resonant laser is irradiated to the laser beam expander mirror 112; using such a detection method, temperature and wind information of the E-F regions can also be obtained by inversion.

As can be seen from the above specific description of the present invention, the present invention extends the detection range of wind field, temperature and density from the bottom of the layer E to the layer F, thereby greatly expanding the lidar's detection range of wind field, temperature and density, and achieving an unprecedented breakthrough of new technology for detecting wind field, temperature and density.

Finally, it should be noted that the above embodiments are only used for describing instead of limiting the technical solutions of the present invention. Although the present invention is described in detail with reference to the embodiments, persons of ordinary skill in the art should understand that modifications or equivalent substitutions of the technical solutions of the present invention should be encompassed within the scope of the claims of the present invention so long as they do not depart from the spirit and scope of the technical solutions of the present invention.

1. A metal ion-based lidar for detecting the wind-temperature-density in E-F regions, wherein the lidar uses metal ions as tracers to detect the E-F regions in the atmosphere, and the lidar comprises a laser emission system (1), a telescope receiving system (2), and a signal acquisition and processing system (3);
the laser emission system (1) is configured to output three-frequency-switched laser for detecting metal ions, by using various laser devices and under the action of optical switches and a frequency converter; the combination of laser beam splitter mirrors and laser highly reflective mirrors realizes laser emission in different directions which are consistent with receiving directions of the telescope receiving system (2);
the telescope receiving system (2) is configured to receive echo signals in various directions, process the echo signals in the various directions separately to obtain electrical signals, and then transmit the electrical signals to the signal acquisition and processing system (3) in a unified manner; and
the signal acquisition and processing system (3) is configured to acquire and process the electrical signals transmitted by the telescope receiving system (2) to obtain the temperature and wind field in the E-F regions and the density of a metal layer.

2. The metal ion-based lidar for detecting the wind-temperature-density in E-F regions according to claim 1, wherein the laser emission system comprises: a first seed laser (101), a high-power pulse pumped laser (102), an optical parametric oscillator-amplifier laser (103), a second seed laser (104), a three-frequency switching module (110), a nonlinear frequency converter (111), a laser beam expander mirror (112), a first laser beam splitter mirror (113), a second laser beam splitter mirror (114), a first laser highly reflective mirror (115), a second laser highly reflective mirror (116), and a third laser highly reflective mirror (117);
the first seed laser (101) is configured to generate narrow-line-width seed laser and inject the narrow-line-width seed laser into the high-power pulse pumped laser (102);
the high-power pulse pumped laser (102) is configure to generate single-longitudinal-mode pumped laser based on the injected narrow-line-width seed laser, and inject the pumped laser light into the optical parametric oscillator-amplifier laser (103), or inject the pumped laser into the optical parametric oscillator-amplifier laser (103) and the nonlinear frequency converter (111);
the second seed laser (104) is configured to generate narrow-line-width seed laser, and input the narrow-line-width seed laser into the three-frequency switching module (110);
the three-frequency switching module (110) is configured to perform frequency shifting on the input narrow-line-width seed laser, specifically: converting the narrow-line-width seed laser with a frequency f₀ injected by the second seed laser (104) into laser with frequencies f₀+Δf, f₀ and f₀−Δf, and injecting the frequency-converted laser into the optical parametric oscillator-amplifier laser (103), where Δf is a frequency shift amount, which is set according to wind and temperature measurement principles;
the optical parametric oscillator-amplifier laser (103) is configured to generate single-longitudinal-mode narrow-line-width signal laser based on the laser injected by the high-power pulse pumped laser (102) and the three-frequency switching module (110), and irradiate the single-longitudinal-mode narrow-line-width signal laser to the nonlinear frequency converter (111);
the nonlinear frequency converter (111) is configured to generate metal-ion resonant laser by an optical nonlinear effect based on the signal laser irradiated by the optical parametric oscillator-amplifier laser (103), or based on two types of laser irradiated by both the high-power pulse pumped laser (102) and the optical parametric oscillator-amplifier laser (103), and irradiate the metal-ion resonant laser to the laser beam expander mirror (112);
the laser beam expander mirror (112) is configured to adjust a beam divergence angle of the metal-ion resonant laser irradiated by the nonlinear frequency converter (111), and irradiate the adjusted beam to the first laser beam splitter mirror (113);
the first laser beam splitter mirror (113) is configured to split the metal-ion resonant laser irradiated by the laser beam expander mirror (112) into two beams, a transmitted beam and a reflected beam;
the second laser highly reflective mirror (116) is configured to reflect the reflected beam output from the first laser beam splitter mirror (113) into the sky in a direction pointing east or west;
the second laser beam splitter mirror (114) is configured to split the transmitted beam output from the first laser beam splitter mirror (113) into two beams, a transmitted beam and a reflected beam again, and reflect the reflected beam into the sky in a direction pointing vertically; and
the first laser highly reflective mirror (115) is configured to reflect the transmitted beam output from the second laser beam splitter mirror (114) to the third laser highly reflective mirror

(117) such that the beam is reflected by the third laser highly reflective mirror (117) into the sky in a direction pointing south or north.

3. The metal ion-based lidar for detecting the wind-temperature-density in E-F regions according to claim 2, wherein the three-frequency switching module (110) comprises a first optical switch (105), a frequency up-converter (106), an optical fiber (107), a frequency down-converter (108), and a second optical switch (109);
the frequency up-converter (106) is configured to perform frequency up-shifting on the laser light input into the three-frequency switching module (110), so that an output laser frequency is converted from f₀ to f₀+Δf;
the optical fiber (107) is configured to directly transmit the laser input into the three-frequency switching module (110);
the frequency down-converter (108) is configured to perform frequency down-shifting on the laser injected into the three-frequency switching module (110), so that an output laser light frequency is converted from f₀ to f₀−Δf;
the frequency up-converter (106), the optical fiber (107) and the frequency down-converter (108) are connected to the second seed laser (104) via the first optical switch (105) and connected to the optical parametric oscillator-amplifier laser (103) via the second optical switch (109), respectively, for controlling a frequency of the laser input to the three-frequency switching module (110) to be processed in an up-shift, down-shift or unchanged manner;
the first optical switch (105) is configured to control timing switching of the second seed laser (104) irradiating to the frequency up-converter (106), the optical fiber (107) and the frequency down-converter (108); and
the second optical switch (109) is configured to control the laser, which is subjected to the timing switching of the frequency up-converter (106), the optical fiber (107) and the frequency down-converter (108), to be irradiated to the optical parametric oscillator-amplifier laser (103).

4. The metal ion-based lidar for detecting the wind-temperature-density in E-F regions according to claim 2, wherein the telescope receiving system (2) comprises: a zenith pointing east or west receiving telescope (201), a zenith pointing vertical receiving telescope (202), a zenith pointing south or north receiving telescope (203), a first optical signal transmitting fiber (204) a second optical signal transmitting fiber (205), a third optical signal transmitting fiber (206), a first optical signal collimating focuser (207), a second optical signal collimating focuser (208), a third optical signal collimating focuser (209), a first photodetector (210), a second photodetector (211), and a third photodetector (212);
the zenith pointing east or west receiving telescope (201) is configured to receive back-scattered echo signals of the laser reflected into the air by the second laser highly reflective mirror (116) and converge the signals into the third optical signal transmitting fiber (206) so as to be transmitted to the first optical signal collimating focuser (207); the first optical signal collimating focuser (207) is configured to focus optical signals and inject the focused optical signals into a detection end face of the first photodetector (210); and the first photodetector (210) is configured to convert the optical signals into electrical signals and output the electrical signals;
the zenith pointing vertical receiving telescope (202) is configured to receive back-scattered echo signals of the laser reflected into the sky by the second laser beam splitter mirror (114) and converge the signals into the second optical signal transmitting fiber (205) so as to be transmitted to the second optical signal collimating focuser (208); the second optical signal collimating focuser (208) is configured to focus optical signals and inject the focused optical signals into a detection end face of the second photodetector (211); and the second photodetector (211) is configured to convert the optical signals into electrical signals and output the electrical signals;
the zenith pointing south or north receiving telescope (203) is configured to receive back-scattered echo signals of the laser light reflected into the sky by the third laser highly reflective mirror (117) and converge the signals into the first optical signal transmitting fiber (204) so as to be transmitted to the third optical signal collimating focuser (209); the third optical signal collimating focuser (209) is configured to focus optical signals and inject the focused optical signals into a detection end face of the third photodetector (212); and the third photodetector (212) is configured to convert the optical signals into electrical signals and output the electrical signals.

5. The metal ion-based lidar for detecting the wind-temperature-density in E-F regions according to claim 4, wherein the signal acquisition and processing system comprises: a multi-channel data acquisition module (301) configured to receive the electrical signals output by the first photodetector (210), the second photodetector (211) and the third photodetector (212).

6. The metal ion-based lidar for detecting the wind-temperature-density in E-F regions according to claim 5, wherein the signal acquisition and processing system further comprises: a timing control module (302), a first timing control signal line (303), a second timing control signal line (304), a third timing control signal line (305), a fourth timing control signal line (306), and a fifth timing control signal line (307); and
the timing control module (302) is configured to control signal synchronization of the high-power pulse pumped laser (102), the three-frequency switching module (110) and the multi-channel data acquisition module (301) via the first timing control signal line (303), the second timing control signal line (304), the third timing control signal line (305), the fourth timing control signal line (306) and the fifth timing control signal line (307).

7. A detection method of a metal ion-based lidar for detecting the wind-temperature-density in E-F regions, which is used to detect the wind-temperature-density in E-F regions based on the metal ion-based lidar for detecting the wind-temperature-density in E-F regions of claim 6, wherein the method comprises:
injecting, by the first seed laser (101), narrow-line-width seed laser into the high-power pulse pumped laser (102) to generate single-longitudinal-mode pumped laser, and injecting the pumped laser light into the optical parametric oscillator-amplifier laser (103), or injecting the pumped laser light into the optical parametric oscillator-amplifier laser (103) and the nonlinear frequency converter (111);
inputting, by the second seed laser (104), narrow-line-width seed laser light into the three-frequency switching module (110);
outputting, by the timing control module (302), a timing control signal, and transmitting the timing control signal to the three-frequency switching module (110) via the third timing control signal line (305), the fourth timing control signal line (306) and the fifth timing control signal line (307); controlling, by the three-frequency switching module (110), a first optical switch (105) and a second optical switch (109) to be communicated with a frequency up-converter (106) a frequency down-converter (108) or an optical fiber (107) according to the timing control signal, such that the input laser passes through the frequency up-converter (106), the frequency down-converter (108) or the optical fiber (107) respectively according to a time series, so that a frequency of output laser is processed in an up-shift, down-shift or unchanged manner, and injecting the processed laser into the optical parametric oscillator-amplifier laser (103) in a time-division manner based on timing control;
generating, by the optical parametric oscillator-amplifier laser (103), single-longitudinal-mode narrow-line-width signal laser under the joint action of a pumping effect of the high-power pulse pumped laser (102) and the laser input from the ) to three-frequency switching module (110), and irradiating the single-longitudinal-mode narrow-line-width signal laser to the nonlinear frequency converter (111) to obtain metal-ion resonant laser, or irradiating both the generated single-longitudinal-mode narrow-line-width signal laser and the single-longitudinal-mode pumped laser generated by the high-power pulse pumped laser (102) to the nonlinear frequency converter (111) to obtain metal-ion resonant laser, and irradiating the metal-ion resonant laser to the laser beam expander mirror (112);
splitting, by the first beam splitter mirror (113), the light output by the laser beam expander mirror (112) into two beams, a transmitted beam and a reflected beam, wherein the reflected beam is irradiated to the second highly reflective mirror (116) and reflected by the second highly reflective mirror (116) into the sky in a direction pointing east or west, and the transmitted beam is irradiated to the second beam splitter mirror (114);
splitting, by the second beam splitter mirror (114), the irradiated beam into two beams, a transmitted beam and a reflected beam again, wherein the reflected beam is reflected directly into the sky in a direction pointing vertically, and the transmitted beam is irradiated to the first highly reflective mirror (115);
reflecting, by the first highly reflective mirror (115), the light to a third highly reflective mirror (117), and reflecting, by the third highly reflective mirror (117), the light into the sky in a direction pointing south or north;
receiving, by the zenith pointing east or west receiving telescope (201), back-scattered echo signals of the laser reflected into the sky by the second high reflector (116), wherein the back-scattered echo signals are generated by resonant scattering of the laser emitted into the sky with metal layer ions, and converging the signals into the third optical signal transmitting fiber (206) so as to be transmitted to the first optical signal collimating focuser (207); focusing optical signals and injecting the focused optical signals into the detection end face of the first photodetector (210) by the first optical signal collimating focuser (207); and converting the optical signals into electrical signals and outputting the electrical signals by the first photodetector (210);
receiving, by the zenith pointing vertical receiving telescope (202), back-scattered echo signals of the laser reflected into the sky from the second beam splitter mirror (114), and converging the signals into the second optical signal transmitting fiber (205) so as to be transmitted to the second optical signal collimating focuser (208); focusing optical signals and injecting the focused optical signals into the detection end face of the second photodetector (211) by the second optical signal collimating focuser (208); and converting the optical signals into electrical signals and outputting the electrical signals by the second photodetector (211);
receiving, by the zenith pointing south or north receiving telescope (203), back-scattered echo signals of the laser reflected into the air from the third highly reflective mirror (117), and converging the signals into the first optical signal transmitting fiber (204) so as to be transmitted to the third optical signal collimating focuser (209); focusing optical signals and injecting the focused optical signals into the detection end face of the third photodetector (212) by the third optical signal collimating focuser (209); and converting the optical signals into electrical signals and outputting the electrical signals by the third photodetector (212); and
receiving, by the multi-channel data acquisition module (301), the electrical signals output by the first photodetector (210), the second photodetector (211) and the third photodetector (212).

8. The detection method of a metal ion-based lidar for detecting the wind-temperature-density in E-F regions according to claim 7, wherein controlling, by the three-frequency switching module (110), a first optical switch (105) and a second optical switch (109) to be communicated with a frequency up-converter (106), a frequency down-converter (108) or an optical fiber (107) according to the timing control signal, so that a frequency of injected laser is processed in an up-shift, down-shift or unchanged manner, and injecting the processed laser into the optical parametric oscillator-amplifier laser (103) specifically comprises:
when the timing control module (302) outputs the timing control signal via the third timing control signal line (305), and when the control signal is at a high level, a first channel of the first optical switch (105) is turned on, and an optical signal is fed into the frequency up-converter (106) so that the frequency of the laser is converted from f₀ to f₀+Δf, and then the optical signal is fed into a first channel of the second optical switch (109); at that time, under timing signal control, the control signal is also at a high level, so that the first channel is turned on, and finally the optical signal with the frequency f₀+Δf is injected into the optical parametric oscillator-amplifier laser (103); the duration of the high level is Δt, and when the control signal is converted from the high level to a low level after the elapse of the time Δt, the first channel of the first optical switch (105) and the first channel of the second optical switch (109) are turned off; the third timing control signal line (305), the fourth timing control signal line (306), and the fifth timing control signal line (307) output alternate high and low levels, wherein the duration of the low level is 2Δt;
when the timing control module (302) outputs the timing control signal via the fourth timing control signal line (306), and when the control signal is at a high level, a second channel of the first optical switch (105) is turned on, and an optical signal is fed into a second channel of the second optical switch (109), so that the second channel is turned on under timing signal control; the frequency of the optical signal is unchanged at that time and is f₀, and finally the optical signal with the frequency f₀ is injected into the optical parametric oscillator-amplifier laser (103); and
when the timing control module (302) outputs the timing control signal via the fifth timing control signal line (307), and when the control signal is at a high level, a third channel of the first optical switch (105) is turned on, and an optical signal is fed into the frequency down-converter (108), so that the frequency of the laser is converted from f₀ to f₀−Δf, then the optical signal is fed into a third channel of the second optical switch (109), the third channel is turned on under timing signal control, and finally the optical signal with the frequency f₀−Δf is injected into the optical parametric oscillator-amplifier laser (103).

9. The detection method of a metal ion-based lidar for detecting the wind-temperature-density in E-F regions according to claim 8, wherein the frequency shift amount Δf has a plurality of set values according to wind and temperature measurement principles.
